(19) United States
(12) Patent Application Publication
(10) Pub. No.: US 2006/0196184 A1
(43) Pub. Date: Sep. 7, 2006

(54) Helical screw expander for power production from solar, geothermal, and industrial processes

(76) Inventor: Roger S. Sprankle, Paso Robles, CA (US)

Correspondence Address: ROGER S. SPRANKLE, P.O. BOX 2701, PASO ROBLES, CA, 93447, US

(21) Appl. No.: 11/071,758

(22) Filed: Mar. 4, 2005

(51) Int. Cl. F03G 6/00; B60K 16/00; B60L 8/00

(52) U.S. Cl. 60/641.8

(57) ABSTRACT

The current design relates back to a twin-screw supercharger invented in the 1930's by Mr. Alf Lysholm who was then Chief Engineer of SRM (Svenska Rotor Maskiner AB) and the design of an expander with specific application objectives that resulted in two patents (U.S. Pat. No. 3,751,673 issued Aug. 7, 1973 and U.S. Pat. No. 3,977,818 issued Aug. 31, 1976). The present design departs from helical rotors used in all prior designs. The present design is more suitable for use as an engine (prime move) for use with lower temperature geothermal hot (warm) waters and brines, waters and brines found in solar salt gradient ponds, and other industrial applications. Thermodynamically speaking, the path through the engine causes isentropic expansion from the saturated liquid line.

### FIELD OF INVENTION

The field of the invention relates to power recovery from the heat energy contained in hot waters and brines. In particular, the solar heat energy in the form of hot (or warm) water or brine, the geothermal heat energy in the form of hot (or warm) water or brine, and the industrial processes waste heat energy in the form of hot (or warm) water or brine.

### BACKGROUND OF THE INVENTION

The invention is a design improvement from the prior art contained in U.S. Pat. No. 3,751,673 issued Aug. 7, 1973 and U.S. Pat. No. 3,977,818 issued Aug. 31, 1976. The invention recovers power from hot (or warm) water or brine. Thermodynamically, the process approached isentropic expansion from the saturated liquid line.

This invention can be used to produce power from solar heat energy that is collected and gathered in the form of hot (or warm) water or brine. As an example, salt gradient solar ponds capture and store solar energy in the form of hot (or warm) brine in the pond bottom. This invention can convert the solar energy contained in the brine into useful mechanical power to drive electric generators, pumps, compressors, etc. This invention can also be used in industrial processes where hot water or brine is wasted and unused.

FIGS. 1 and 2 show the prior art where a helical screw expander is used to recover power from geothermal hot water. The prior art involves a pair of constant twist helical screw rotors.

FIGS. 3, 4, and 5 show the invention. Such a design improves the power conversion efficiency for better resource utilization.

### BRIEF DESCRIPTION OF THE DRAWINGS

FIGS. 1 and 2 show the prior art.

FIG. 3 is a view of the invention showing the various important elements. A condenser, not shown, is used to maintain the vacuum in the exhaust. The inlet port is where the hot (or warm) water or brine enters the invention. Between the inlet port and exhaust, the hot (or warm) water or brine rapidly boils (expands or flashes). It is this expansion that drives (or spins) the rotors, producing mechanical power. A generator can convert this mechanical power to electricity. The boiling fluid expands away from the inlet port in both axial directions, eliminating thrust loads, and the need for thrust bearings. The shaft seals are located in the exhaust and prevent air entry.

FIG. 4 shows the rotors. Through A-A the rotors reverse twist, and the left side is the mirror image of the right side. This symmetrical design, centered on the inlet port, eliminates heavy thrust loads and the need for thrust bearings as in the prior art. The rate of twist also changes, going from a high twist to a low twist and then back to a high twist. This changing twist increases the fluid expansion for improved energy conversion.

FIG. 5 is a cross section of A-A and shows the control valve (U.S. Pat. No. 3,977,818) This control valve is a variable converging nozzle. The flow across the valve is essentially isentropic and assists in maximizing the power recovery.

FIGS. 6 and 7 show the possible range of rotor profiles for this invention. The rotors can be symmetrical or asymmetrical as shown in FIG. 6. FIG. 7 shows the range of possible profiles used at different cross sections of the rotors.

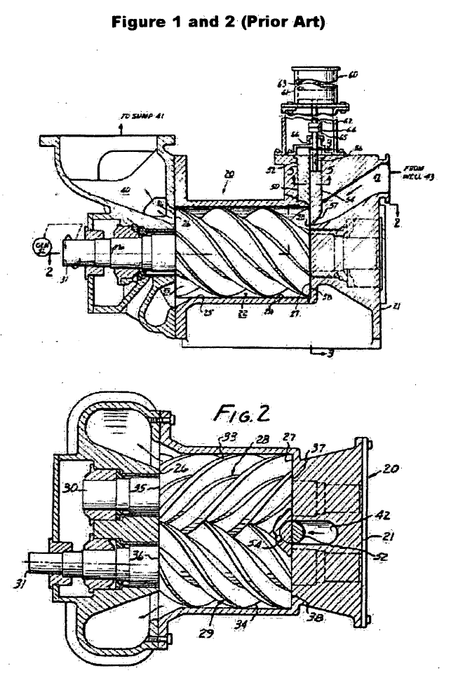

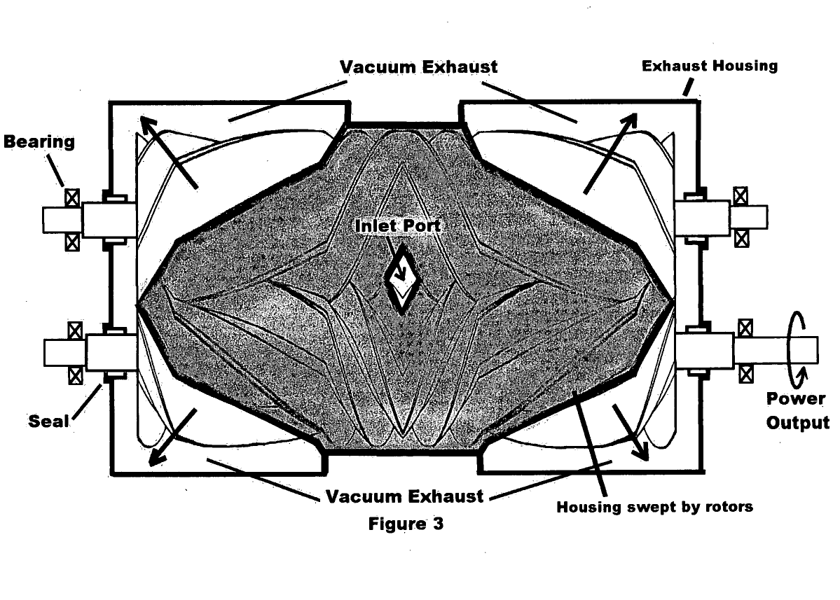

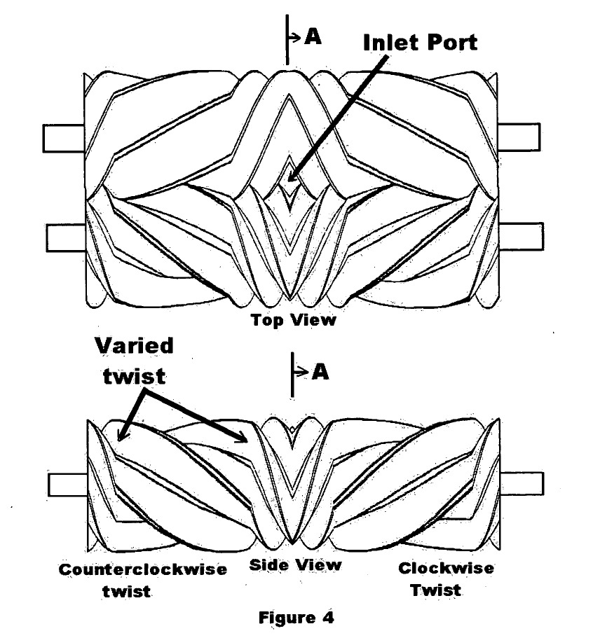

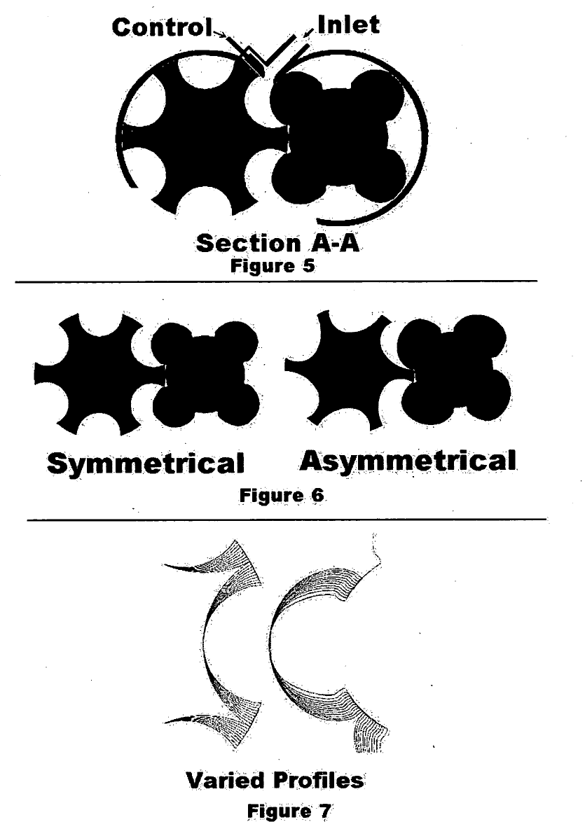

What is claimed is:

1. A helical screw expander that has a reversing twist, and/or variable twist, and/or a variable profile for use with fluid sources that are hot (or warm) water or brine.

2. A helical screw expander that has a reversing twist, and/or a variable twist, and/or a variable profile where the fluid source is either geothermal or solar produced hot (or warm) water or brine.

3. A helical screw expander that has a reversing twist, and/or a variable twist, and/or a variable profile where the fluid source is solar produced hot (or warm) water or brine that is collected in a salt gradient solar pond.
